(19) United States
(12) Patent Application Publication
(10) Pub. No.: US 2026/0182597 A1
(43) Pub. Date: Jul. 2, 2026

(54) METHOD FOR THE MANUFACTURE OF SPICED SMOKED CHEESE

(71) Applicants: Ronald G. Loman, Lexington, NC (US); Jamie L. Loman, Lexington, NC (US)

(72) Inventors: Ronald G. Loman, Lexington, NC (US); Jamie L. Loman, Lexington, NC (US)

(21) Appl. No.: 19/436,629

(22) Filed: Dec. 30, 2025

Related U.S. Application Data
(60) Provisional application No. 63/740,476, filed on Dec. 31, 2024.

(51) Int. Cl. A23C 19/14; A01J 27/00; A23B 4/052; A23C 19/076; A23C 19/09; B65B 25/06; B65B 31/00; B65B 61/26; C10L 5/44

(52) U.S. Cl. CPC A23C 19/14; A01J 27/005; A23B 4/052; A23C 19/076; A23C 19/09; B65B 25/068; B65B 31/00; B65B 61/26; C10L 5/442; A23C 2250/35

(57) ABSTRACT

The application generally relates to a method of combining cheese and curated spices then placing the product in a ceramic smoker for a designated amount of time. The application relates more specifically to a method of combining cream cheese and spices, using natural wood to heat the ceramic smoker and natural wet wood chips to create a unique smoked flavor. This method produces thoroughly smoked and spiced soft cheeses that are packaged and ready to ship nationwide.

### CROSS-REFERENCE TO RELATED APPLICATIONS

This application relates to U.S. Provisional Application Ser. No. 63/740,476 of the same title filed on Dec. 31, 2024, as a non-provisional utility application of the same invention and, to the fullest extent allowable, claims the benefit and priority of the same.

### BACKGROUND

The application generally relates to a method of combining cheese and curated spices then placing the product in a ceramic smoker for a designated amount of time. The application relates more specifically to a method of combining cream cheese and spices, using natural wood to heat the ceramic smoker and spiced cheese product to capture a unique flavor.

Preparing, serving, and consuming unique flavors derived from diverse recipes is one of the most pleasurable culinary activities, especially when those flavors can be packaged, shipped, purchased, and transported to any home or gathering.

Cheese spreads, charcuterie boards, grocery stores and delis provide partakers and customers with an opportunity to select ingredients which will provide nutrients and pleasurable gastrointestinal experiences. However, the method of preparation of the existing cheese spreads does not presently provide customers with the specific combination of spices blended into cream cheese and placed in a warmer/ceramic smoker with natural wood chips for approximately two hours or more until the cheese is uniquely and thoroughly flavored in a manner that is distinguishable from any other product on the market.

Cream cheese is a soft cheese made from ingredients including milk and cream, and is generally spreadable. It is also generally mild-tasting unless given a specific flavor by adding various ingredients.

Foodstuffs may be smoked for different purposes using various processes. The temperature within the smoker, the time during which the smoking process occurs, the particular accelerants used to create the heat and smoke all vary depending on the purpose and items being prepared.

Clearly, there is a need for an improved method of spicing and smoking cheese, specifically cream cheese, using natural wood lump coal and natural wet wood, as opposed to alternative means of heating a smoker, to create a unique flavor for customers.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY

Disclosed herein are various example embodiments of the present general inventive concept. One embodiment relates to a ceramic smoker that is heated up to a temperature of 200 degrees Fahrenheit using natural wood lump coal and a natural wet wood which may be selected from apple, cherry, plum, peach, and maple. The internal temperature of the smoker is maintained by allowing the natural lump coal to burn down and decrease the internal temperature of the smoker or by the addition of natural lump coal and hickory to increase the internal temperature of the smoke and continue to create a quality smoke. In some embodiments, the internal temperature is maintained at 160 degrees Fahrenheit for two hours. Each individual bar of cream cheese is flavored with a unique recipe of spices and kneaded to thoroughly distribute the spices throughout. The bar is reshaped to be approximately 1.5 inches thick. The bar is placed on a low heat pallet sheet; such as paper, wood board, or aluminum foil. Each bar is then scored to enhance the absorption of the smoke flavor. The bars are placed in the smoker for two hours and then removed to cool. Once rested, the bar is placed on a new food grade sheet, packaged, labeled and refrigerated.

Other embodiments relate to a method of kneading the spice mix into the bar of cream cheese and reshaping it to be approximately 1.5 inches thick. Then an additional coat of spices is applied to the outside of a bar before it is scored and placed in the smoker. Then the bar is smoked, removed, cooled, packaged, labeled, and refrigerated.

An object of the invention is to provide a unique method of flavoring cream cheese using high quality ingredients and a consistent temperature and time frame to obtain a superior and desirable flavor that can be maintained within the cheese product and sold at a later date.

It is an object of the invention to provide a cheese bar that contains a natural wood smoked flavor which pairs superbly with wine, meats, crackers, cigars, and other items.

It is a further object of the invention to provide a spiced and smoked cream cheese that can be transported far distances while still maintaining its freshness and flavor.

It is still a further object of the invention to provide a method of combining spices, cheese, heat, and time to overcome the burnt flavor that results from using standard wood pellets to heat food.

It is still a further object of the invention to provide a method of batch smoking a soft cheese product with a consistent flavor profile for sale.

Alternative exemplary embodiments relate to other features and combinations of features as may be generally recited in the pending claims.

### BRIEF DESCRIPTION OF THE FIGURES

FIG. 1 is a flow diagram illustrating in general terms one example embodiment of the present general inventive concept.

### DETAILED DESCRIPTION OF THE EXEMPLARY EMBODIMENTS

Before turning to the figures which illustrate the exemplary embodiments in detail, it should be understood that the application is not limited to the details or methodology set forth in the following description or illustrated in the figures.

It should also be understood that the phraseology and terminology employed herein is for the purpose of description only and should not be regarded as limiting.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the steps as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

It should be noted that although the figures herein may show a specific order of method steps, it is understood that the order of these steps may differ from what is depicted. Also, two or more steps may be performed concurrently or with partial concurrence. Such variation will depend on the particular apparatus chosen to implement the methods. It is understood that all such variations are within the scope of the application.

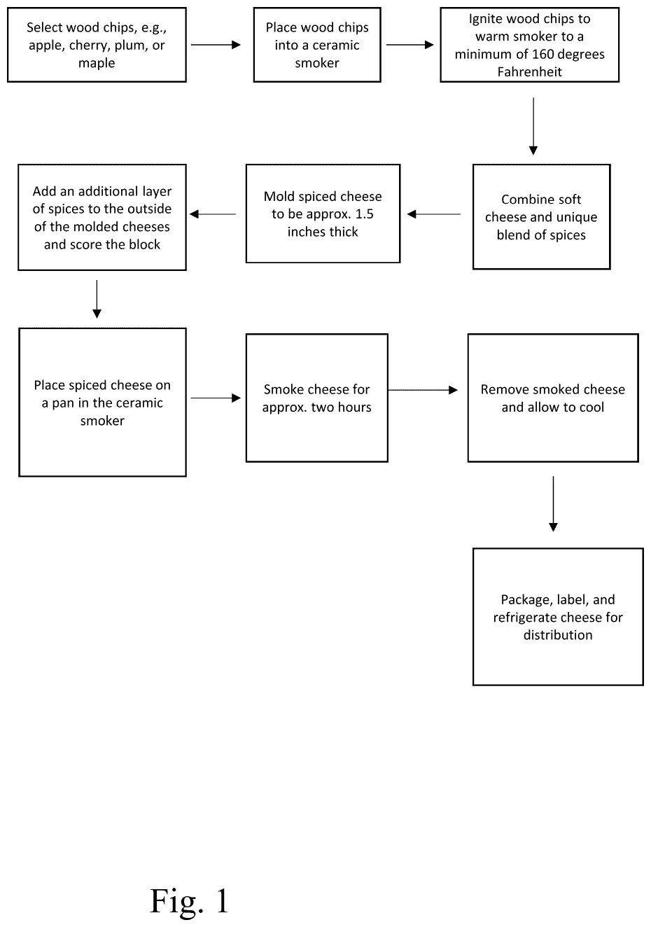

FIG. 1 shows a flow diagram illustrating in general terms an example method or process according to one example embodiment of the present general inventive concept. As shown in FIG. 1, wood chips are selected depending on the desired smoke flavor, which may be apple, cherry, plum, or maple. The wood chips are places into a ceramic smoker apparatus heated with natural wood lump coal to a temperature of at least 160 degrees Fahrenheit and ignited. A soft cheese, which may be a cream cheese, is combined with a unique blend of herbs and spices, then molded into a brick-like or bar shape approximately 1.5 inches thick. Once molded, an additional layer of herbs and spices is applied to the outer surface of the cheese bar. The cheese bar is then scored to allow smoke to penetrate the surface of the bar. The bar is then placed inside the ceramic smoker apparatus on a pan or other surface capable of holding the bar in place, such as paper, a wood board, or aluminum foil. The cheese bar then remains in the ceramic smoker apparatus for approximately two hours before it is removed and allowed to cool completely. Once cooled, the smoked and spiced cheese bar is packaged, labeled, and refrigerated in preparation for distribution.

The process described herein is compatible with various types of soft cheeses, various types of herbs and spices, and various types of wood chips to adjust for distinct flavor profiles.

The process described herein allows for bars of an approximate thickness, but of various lengths, or that can be smoked at one length and cut and packaged for distribution at another, shorter length. In some embodiments, the resulting product is approximately 3 inches wide by 4 inches long by 1.5 inches thick.

In some embodiments, the scoring of the cheese bars is in an approximately ¾ inch grid pattern. In some embodiments, the scoring of the cheese bars is in an approximately ¾ inch diamond pattern.

In some embodiments, the natural lump wood coal is oak, hickory, or a combination of both oak and hickory.

In some embodiments, the wet smoking wood chips are of apple, cherry, pecan, peach, plum, maple, or any combination thereof.

In some embodiments, the resulting product is vacuum sealed prior to distribution to preserve freshness and flavor.

The process described herein contemplates a ceramic smoker apparatus, but can be adjusted for alternative smoker apparatuses.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Moreover, in the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the detailed description are hereby expressly incorporated into this detailed description, with each claim standing on its own as a separate embodiment of the invention.

1. A method of manufacturing a spiced and smoked cheese, comprising:
providing a heated smoker apparatus;
placing natural wet smoking wood in the smoker apparatus;
combining a soft cheese with a spice blend;
kneading the soft cheese and spice blend so that the spice blend is distributed evenly throughout the soft cheese;
forming the combined soft cheese and spice blend into a bar;
placing the bar on a pallet sheet;
scoring each bar to promote smoke penetration;
placing the pallet sheet in the smoker apparatus; and
removing the pallet sheet from the smoker apparatus after the bar is adequately smoked.

2. The method of claim 1, wherein the smoker apparatus is heated using natural wood lump coal.

3. The method of claim 1, wherein the smoker apparatus is heated to at least 160 degrees Fahrenheit.

4. The method of claim 1, wherein the pallet sheet is placed in the smoker apparatus for approximately two hours before being removed.

5. The method of claim 1, wherein the bar is approximately 1.5 inches thick.

6. The method of claim 1, wherein the bar is coated with an additional coat of the spice blend after the soft cheese is kneaded with the spice blend and formed into a bar.

7. The method of claim 1, further comprising packaging, labeling, and refrigerating the bar after it is removed from the smoker apparatus and allowed to cool.

8. The method of claim 1, wherein the natural wet smoking wood is at least one species selected from the group of apple, cherry, pecan, plum, peach, and maple.

9. The method of claim 2, wherein the natural wood lump coal is at least one species selected from the group of oak and hickory.

10. The method of claim 5, wherein the bar is approximately 3 inches wide by 4 inches long.

11. The method of claim 1, wherein the smoker apparatus is a ceramic smoker apparatus.

12. The method of claim 7, wherein the bar is packaged by vacuum sealing.

13. The method of claim 1, wherein the bar is scored in an approximately ¾ inch grid pattern.

14. The method of claim 1, wherein the bar is scored in an approximately ¾ inch diamond pattern.

15. The method of claim 1, wherein the soft cheese is a cream cheese.

16. The method of claim 1, wherein the pallet sheet is made of a material selected from the group of paper, wood, or aluminum.

17. The method of claim 1, wherein the method is repeated and batched so that multiple bars may be smoked in the smoker apparatus at the same time.

18. A method of manufacturing a spiced and smoked cheese, comprising:
heating a ceramic smoker apparatus using natural wood lump coal to approximately 200 degrees Fahrenheit;
placing natural wet smoker wood chips in the smoker apparatus;
allowing the smoker apparatus to lower in temperature to approximately 160 degrees Fahrenheit;
kneading a bar of cream cheese with a unique blend of herbs and spices;
forming the kneaded and spiced cream cheese into a bar or similar shape;
placing the bar on a sheet pan adapted for use in the smoker apparatus;
scoring the top of the bar to allow for maximum smoke penetration;
placing the sheet pan in the smoker apparatus for approximately two hours;
removing the sheet pan from the smoker apparatus after two hours and allowing the bar to cool completely; and
packaging, labeling, and refrigerating to bar in preparation for distribution.

19. The method of claim 18, wherein the method is repeated and batched so that multiple bars may be smoked in the smoker apparatus and prepared for distribution at the same time.

20. The method of claim 18, wherein the natural wood lump coal is at least one species selected from the group of oak and hickory, and the natural wet smoking wood is at least one species selected from the group of apple, cherry, pecan, plum, peach, and maple.
